(19) United States
(12) Patent Application Publication
(10) Pub. No.: US 2021/0391631 A1
(43) Pub. Date: Dec. 16, 2021

(54) BATTERY AND MANUFACTURING METHOD OF BATTERY

(71) Applicant: KABUSHIKI KAISHA TOSHIBA, Tokyo (JP)

(72) Inventors: Yasuaki HADAME, Tokyo (JP); Shinji NAKATA, Yokohama (JP); Wataru NITTA, Tokyo (JP); Takahiro TERADA, Yokohama (JP); Shinya TANIKAWA, Tokyo (JP)

(73) Assignee: KABUSHIKI KAISHA TOSHIBA, Tokyo (JP)

(21) Appl. No.: 17/341,471

(22) Filed: Jun. 8, 2021

(30) Foreign Application Priority Data
Jun. 16, 2020 (JP) 2020-103554

(51) Int. Cl. H01M 50/533; H01M 50/547; H01M 10/0525

(52) U.S. Cl. CPC H01M 50/533; H01M 10/0525; H01M 50/547

(57) ABSTRACT

A battery of one embodiment includes an electrode group, a current collecting tab, a terminal and a lead. The current collecting tab protrudes outwardly in a lateral direction in the electrode group, and the terminal is deviated from the electrode group in a height direction. The lead includes a top plate portion to which the terminal is connected, and a leg portion bent to the top plate portion toward a side of the electrode group in the height direction. A bending line of the leg portion to the top plate portion is along a depth direction, and the leg portion extends straight from a bending position to a far side end. A leg edge surface facing one side in the depth direction is joined to the current collecting tab in an outer surface of the leg portion.

### CROSS-REFERENCE TO RELATED APPLICATIONS

This application is based upon and claims the benefit of priority from Japanese Patent Application No. 2020-103554, filed Jun. 16, 2020; the entire contents of which are incorporated herein by reference.

### FIELD

Embodiments described herein relate generally to a battery and a manufacturing method of the battery.

### BACKGROUND

In some batteries, such as a lithium ion secondary battery, an electrode group including a positive electrode and a negative electrode is housed in an inner cavity of an outer container. In such a battery, the inner cavity of the outer container is open toward one side of a height direction. A lid member is attached to the outer container, and an opening of the inner cavity is covered with the lid member. In the battery, a terminal is attached to an outer surface of the lid member and is arranged in such a manner as to be deviated from the electrode group toward one side in the height direction. In the electrode group arranged in the inner cavity of the outer container, a current collecting tab protrudes outwardly in a lateral direction intersecting the height direction. The current collecting tab and the terminal are electrically connected to each other with a lead intervening therebetween. Therefore, the lead forms an electric route between the electrode group and the terminal.

Such a battery as described in the above is required to secure a low electric resistance of the lead which serves as the electric route between the electrode group and the terminal, and to achieve a higher output.

### BRIEF DESCRIPTION OF THE DRAWINGS

FIG. 1 is a perspective view schematically showing a battery according to a first embodiment.

FIG. 2 is a perspective view schematically showing the battery according to the first embodiment disassembled into components.

FIG. 3 is a perspective view schematically showing a lead of the battery according to the first embodiment.

FIG. 4 is a perspective view schematically showing a structure of electric connection between an electrode group and a terminal with a lead intervening therebetween in the battery according to the first embodiment.

FIG. 5 is a cross-sectional view schematically showing, in a cross section perpendicular to or substantially perpendicular to a lateral direction of the battery according to the first embodiment, a structure of electric connection between an electrode group and a terminal with a lead intervening therebetween in the battery.

FIG. 6 is cross-sectional view schematically showing, in a cross section perpendicular to or substantially perpendicular to a length direction of the battery group, the electrode group and a current collecting tab of the battery according to the first embodiment.

FIG. 7 is a cross-sectional view schematically showing, in a cross section perpendicular to or substantially perpendicular to a lateral direction of a battery according to a first modification, a structure of electric connection between an electrode group and a terminal with a lead intervening therebetween in the battery.

FIG. 8 is a cross-sectional view schematically showing, in a cross section perpendicular to or substantially perpendicular to a lateral direction of a battery according to a second modification, a structure of electric connection between an electrode group and a terminal with a lead intervening therebetween in the battery.

FIG. 9 is a cross-sectional view schematically showing, in a cross section perpendicular to or substantially perpendicular to a lateral direction of a battery according to a third modification, a structure of electric connection between an electrode group and a terminal with a lead intervening therebetween in a battery.

### DETAILED DESCRIPTION

According to an embodiment, a battery includes an electrode group, a current collecting tab, a terminal, and a lead. The electrode group includes a positive electrode and a negative electrode, and the current collecting tab protrudes outwardly in a lateral direction in the electrode group. The terminal is arranged in such a manner as to be deviated from the electrode group in a height direction intersecting the lateral direction, and the lead electrically connects the electrode group and the terminal. The lead includes a top plate portion to which the terminal is connected, and a leg portion bent with respect to the top plate portion toward a side at which the electrode group is positioned in the height direction. A bending line of the leg portion with respect to the top plate portion is formed along a depth direction intersecting both the lateral direction and the height direction, and the leg portion extends straight along the height direction from a bending position with respect to the top plate portion to a far side end with respect to the top plate portion. An outer surface of the leg portion is provided with a leg edge surface facing one side in the depth direction, and the leg edge surface is joined to a current collecting tab.

Hereinafter, embodiments will be described with reference to the drawings.

### First Embodiment

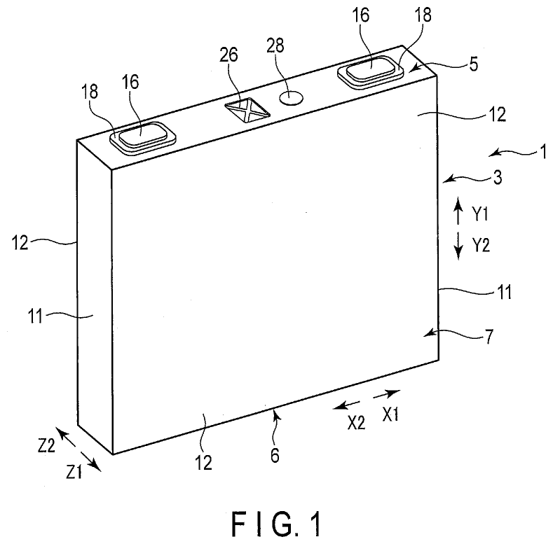

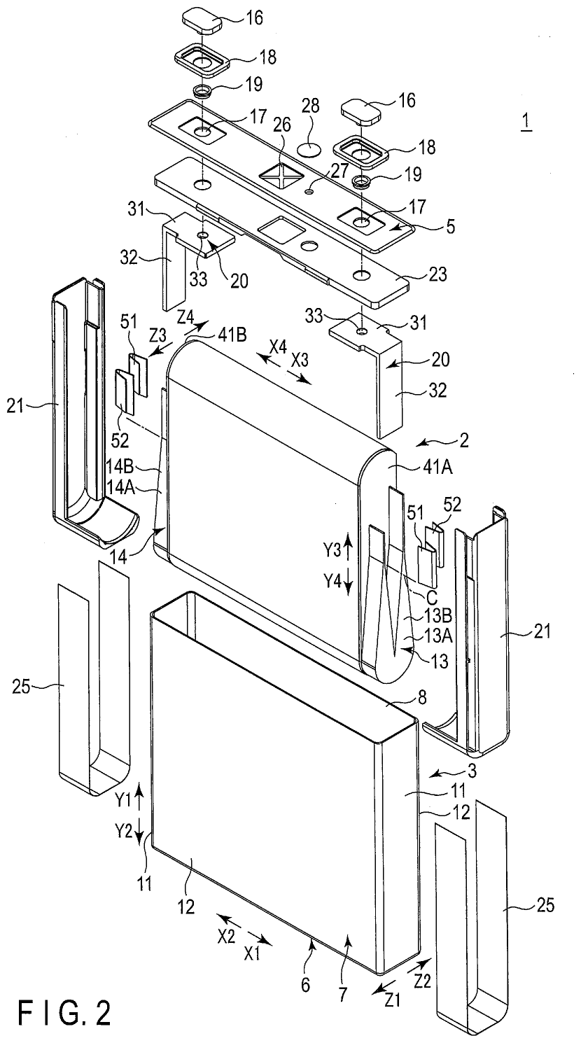

FIGS. 1 and 2 show a battery 1 according to a first embodiment. FIG. 2 shows the battery 1 disassembled into components. As shown in FIGS. 1 and 2, the battery 1 includes an electrode group 2, an outer container 3, and a lid member 5. Each of the outer container 3 and the lid member 5 is formed of a metal such as, e.g., aluminum, an aluminum alloy, iron, copper, or stainless steel. Herein, the battery 1 is defined in terms of a lateral direction (a direction indicated by arrows X1 and X2), a height direction (a direction indicated by arrows Y1 and Y2) intersecting (perpendicular to or substantially perpendicular to) the lateral direction, and a depth direction (a direction indicated by arrows Z1 and Z2) intersecting (perpendicular to or substantially perpendicular to) both the lateral direction and the height direction. The battery 1 and the container 3 each have a smaller dimension in the depth direction than each of the dimension in the lateral direction and the dimension in the height direction.

The outer container 3 includes a bottom wall 6 and a peripheral wall 7. An inner cavity 8 in which the electrode group 2 is housed is defined by the bottom wall 6 and the peripheral wall 7. In the outer container 3, the inner cavity 8 is open toward the side opposite to a side at which the bottom wall 6 is positioned in the height direction. The peripheral wall 7 includes two pairs of side walls, side walls 11 and side walls 12. The side walls 11 that form one pair face each other with the inner cavity 8 intervening therebetween in the lateral direction. The side walls 12 that form one pair face each other with the internal cavity 8 intervening therebetween in the depth direction. Each of the side walls 11 continuously extends in the depth direction between the side walls 12. Each of the side walls 12 continuously extends in the lateral direction between the side walls 11. The lid member 5 is attached to the peripheral wall 7 at an end opposite to the bottom wall 6. Therefore, the lid member 5 covers an opening of the inner cavity 8 of the outer container 3. The lid member 5 and the bottom wall 6 face each other with the inner cavity 8 intervening therebetween in the height direction.

The electrode group 2 includes a positive electrode 13 and a negative electrode 14. In the electrode group 2, a separator (not shown) intervenes between the positive electrode 13 and the negative electrode 14. The separator is made of a material having electrical insulation properties, and electrically insulates the positive electrode 13 from the negative electrode 14.

The positive electrode 13 includes a positive electrode current collector 13A such as a positive electrode current collecting foil, and a positive electrode active material-containing layer (not shown) supported on a surface of the positive electrode current collector 13A. The positive electrode current collector 13A is, but is not limited to, for example, an aluminum foil or an aluminum alloy foil, which has a thickness of about 10 μm to 20 μm. The positive electrode active material-containing layer includes a positive electrode active material, and may optionally contain a binder and an electro-conductive agent. The positive electrode active material is, but is not limited to, for example, oxides, sulfides, and polymers, which can occlude and release lithium ions. The positive electrode current collector 13A includes a positive electrode current collecting tab 13B as a portion not supporting the positive electrode active material-containing layer.

The negative electrode 14 includes a negative electrode current collector 14A such as a negative electrode current collecting foil, and a negative electrode active material-containing layer (not shown) supported on a surface of the negative electrode current collector 14A. The negative electrode current collector 14A is, but is not limited to, for example, an aluminum foil, an aluminum alloy foil, or a copper foil, having a thickness of about 10 μm to 20 μm. The negative electrode active material-containing layer includes a negative electrode active material, and may optionally contain a binder and an electro-conductive agent. The negative electrode active material may be, but is not particularly limited to, a metal oxide, a metal sulfide, a metal nitride, and a carbon material, which can occlude and release lithium ions, for example. The negative electrode current collector 14A includes a negative electrode current collecting tab 14B as a portion not supporting the negative electrode active material-containing layer.

The electrode groups 2 are defined in terms of a length direction (a direction indicated by arrows X3 and X4), a width direction (a direction indicated by arrows Y3 and Y4) intersecting (perpendicular to or substantially perpendicular to) the length direction, and a thickness direction (a direction indicated by arrows Z3 and Z4) intersecting (perpendicular to or substantially perpendicular to) both the length direction and the width direction. The electrode group 2 has a smaller dimension in the thickness direction than each of the dimension in the length direction and the dimension in the width direction. Therefore, the electrode group 2 is formed into, example, a flat shape. In the electrode group 2, the positive electrode current collecting tab 13B protrudes from the negative electrode 14 and the separator toward one side in the length direction. The negative electrode current collecting tab 14B protrudes in the length direction from the positive electrode 13 and the separator toward the side opposite to the side toward which the positive electrode current collecting tab 13B protrudes. In the electrode group 2 according to the present embodiment, the positive electrode 13, the negative electrode 14, and the separator are wound around a winding axis C in a state in which the separator intervenes between the positive electrode active material-containing layer and the negative electrode active material-containing layer. The winding axis C extends in the length direction of the electrode group 2.

In the present embodiment, the electrode group 2 is arranged in the inner cavity 8 in a state in which the length direction of the electrode group 2 corresponds to or substantially corresponds to the lateral direction of the battery 1 (the outer container 3), and the width direction of the electrode group 2 corresponds to or substantially corresponds to the height direction of the battery 1. In the battery 1, the thickness direction of electrode group 2 corresponds to or substantially corresponds to the depth direction of the battery 1. In the inner cavity 8 of the outer container 3, the positive electrode current collecting tab 13B protrudes from the negative electrode 14 and the separator toward one side in the lateral direction of the battery 1. The negative electrode current collecting tab 14B protrudes from the positive electrode 13 and the separator toward the side opposite to the side from which the positive electrode current collecting tab 13B protrudes in the lateral direction of the battery 1.

Furthermore, in the inner cavity 8, the electrode group 2 holds (is impregnated with) an electrolytic solution (not shown). The electrolytic solution may be a nonaqueous electrolytic solution obtained by dissolving an electrolyte in an organic solvent, or an aqueous electrolytic solution such as an aqueous solution. Instead of the electrolytic solution, a gel electrolyte may be used, or a solid electrolyte may be used. In the case where a solid electrolyte is used as an electrolyte, instead of the separator, the solid electrolyte intervenes between the positive electrode 13 and the negative electrode 14 in the electrode group 2. In such a case, the positive electrode 13 is electrically insulated from the negative electrode 14 by the solid electrolyte.

In the battery 1, a pair of terminals 16 are attached to an outer surface (top face) of the lid member 5. The terminals 16 are made of an electro-conductive material such as a metal. One of the terminals 16 is a positive electrode terminal of the battery 1, and the other terminal 16 is a negative electrode terminal of the battery 1. Furthermore, the lid member 5 is provided with a pair of through-holes 17, which penetrate through the lid member 5 in the height direction of the battery 1. Insulating members 18 are respectively provided between the terminals 16 and the lid members 5. Furthermore, insulating gaskets 19 are respectively arranged in the through-holes 17. The terminals 16 are electrically isolated from the lid member 5 and the outer container 3 by the insulating members 18 and the insulating gaskets 19, respectively.

As described in the above, the pair of terminals 16 are provided. Thus, each of the terminals 16 is arranged in such a manner as to be deviated from the electrode group 2 toward one side in the height direction of the battery 1 (the width direction of the electrode group 2). Each of the terminals 16 is arranged on a side at which the lid member 5 is positioned in the height direction of the battery 1 with respect to the electrode group 2, and faces the electrode group 2 from one side in the height direction of the battery 1. Therefore, the negative electrode terminal, which is one of the terminals 16, is arranged in such a manner as to be deviated from the electrode group 2 toward a side at which the positive electrode, which is the other terminal 16 different from the negative electrode terminal, is positioned. Furthermore, the terminals 16 in a pair are separated from each other in the lateral direction of the battery 1 (the length direction of the electrode group 2). The negative electrode terminal is separated from the positive electrode terminal toward a side toward which the negative electrode current collecting tab 14B protrude.

A pair of leads 20 is arranged in the inner cavity 8 of the outer container 3. The positive electrode current collecting tab 13B of the electrode group 2 is electrically connected to the positive electrode terminal, which is a corresponding one of the terminals 16, with a positive electrode side lead, which is a corresponding one of the leads 20, intervening between the positive electrode current collecting tab 13B and the positive electrode terminal. Furthermore, the negative electrode current collecting tab 14B of the electrode group 2 is electrically connected to the negative electrode terminal, which is a corresponding one of the terminals 16, with a negative electrode side lead, which is a corresponding one of the leads 20, intervening between the negative electrode current collecting tab 14B and the negative electrode terminal. In this manner, each of the terminals 16 is electrically connected to the electrode group 2 with a corresponding one of the leads 20 intervening therebetween. Each of the leads 20 is made of an electro-conductive material such as a metal. Examples of an electro-conductive material forming the leads 20 include aluminum, stainless steel, copper, iron, etc.

In the inner cavity 8 of the outer container 3, a pair of insulating guards 21 and an electrode group holder 23 are arranged. Each of the insulating guards 21 is made of an electrically insulating material. The positive electrode side lead, which serves as one of the leads 20, and the positive electrode current collecting tab 13B are each prevented by a corresponding one of the insulating guards 21 from coming into contact with the outer container 3, thereby being electrically insulated from the outer container 3. The negative electrode side lead, which serves as one of the leads 20, and the negative electrode current collecting tab 14B are each prevented by a corresponding one of the insulating guards 21 from coming into contact with the outer container 3, thereby being electrically insulated from the outer container 3. Each of the insulating guards 21 is fixed to the electrode group 2 by means of an insulating tape 25. The insulating tape 25 is made of an electrically insulating material.

The electrode group holder 23 is arranged between the electrode group 2 and the lid member 5 in the height direction of the battery 1. The electrode group holder (the inner insulating member) 23 is made of an electrically insulating material. The positive electrode current collecting tab 13B, the negative electrode current collecting tab 14B, and the pair of leads 20 are prevented by the electrode group holder 23 from coming into contact with the lid member 5, thereby being electrically insulated from the lid member 5.

In one example illustrated in FIGS. 1 and 2, the lid member 5 is provided with a gas discharge valve 26 and a liquid inlet 27. On the outer surface of the lid member 5, a sealing plate 28 configured to seal the liquid inlet 27 is welded. The battery 1 may not be provided with, e.g., the gas discharge valve 26 and the liquid inlet 27.

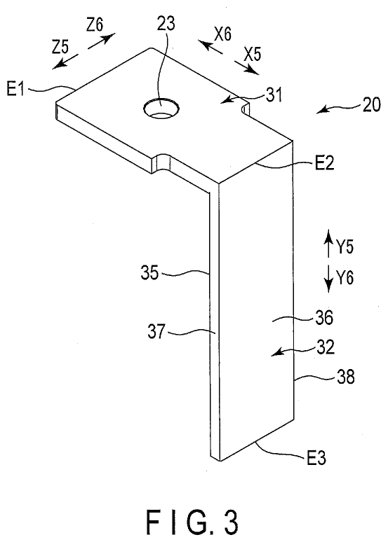

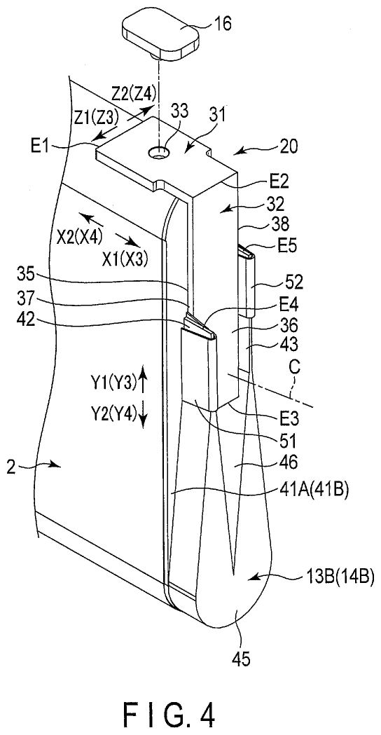

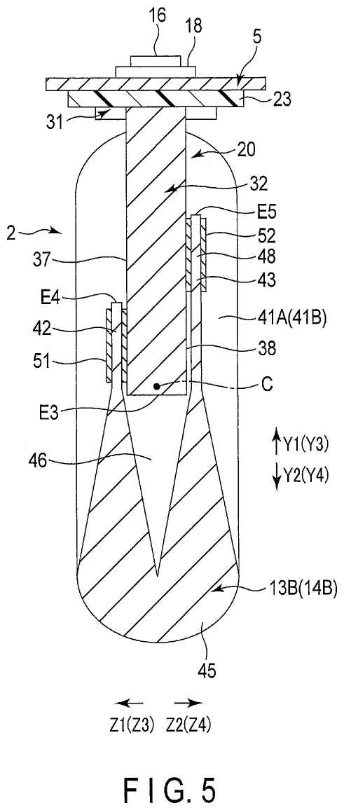

FIG. 3 shows the structure of the leads 20. FIGS. 4 and 5 show a structure of electric connection between the electrode group 2 and each of the terminals 16 with a corresponding one of the leads 20 intervening therebetween. FIGS. 3 and 4 are the perspective views. FIG. 4 omits the outer container 3, the lid member 5, the electrode group holder 23, etc. FIG. 5 shows a cross section perpendicular to or substantially perpendicular to the lateral direction of the battery 1 (the length direction of the electrode group 2), and omits the outer container 3, the insulating guard 21, etc. As shown in FIGS. 2 to 5, each of the leads 20 includes a top plate portion 31 and a leg portion 32.

The top plate portion 31 is defined in terms of a length direction (a direction indicated by arrows X5 and X6), a plate width direction (a direction indicated by arrows Z5, and Z6) intersecting (perpendicular to or substantially perpendicular to) the length direction, and a plate thickness direction (a direction indicated by arrows Y5 and Y6) intersecting (perpendicular to or substantially perpendicular to) both the length direction and the plate width direction. The top plate portion 31 has extension ends E1 and E2, and extends from the extension end E1 to the extension end E2 along the length direction. In the top plate portion 31, a through-hole 33 is formed between the extension ends E1 and E2 in the length direction. The through-hole 33 penetrates through the top plate portion 31 in the plate thickness direction.

Each of the leads 20 is provided with only one leg portion 32. The leg portion 32 is connected to the extension end E2 of the top plate portion 31. The leg portion 32 is bent with respect to the top plate portion 31 while a connection position to the top plate portion 31 (the extension end E2 of the top plate portion 31) serves as a bending position. The leg portion 32 is bent with respect to the top plate portion 31 toward one side in the plate thickness direction of the top plate portion 31 (toward the arrow Y6). Therefore, the leg portion 32 protrudes from the top plate portion 31 toward one side in the thickness direction of the top plate portion 31. A protrusion end of the leg portion 32 from the top plate portion 31 serves as a far side end E3 of the leg portion 32 with respect to the top plate portion 31. In the leg portion 32, the far side end E3 corresponds to the end opposite to the connection position to the top plate portion 31. On the bending position of the leg portion 32 with respect to the top plate portion, a bending line extends along the plate width direction of the top plate portion 31. In the present embodiment, at the bending position of the leg portion 32 with respect to the top plate portion 31, the leg portion 32 is bent at an angle of 90° or substantially 90°.

The leg portion 32 is formed into a plate shape. The leg portion 32 extends straight or substantially straight along the thickness direction of the top plate portion 31 from the bending position with respect to the top plate portion 31 (the connection position to the top plate portion 31) up to the far side end E3 with respect to the top plate portion 31 (the protrusion end from the top plate portion 31). In this manner, the leg portion 32 extends without bending in the length direction of the top plate portion 31 and in the plate width direction of the top plate portion 31 between the connection position to the top plate portion 31 (the extension end E2 of the top plate portion 31) and the far side end E3 with respect to the top plate portion 31. In each of the leads 20, the plate width direction of the leg portion 32 corresponds to or substantially corresponds to the plate width direction of the top plate portion 31, and the plate thickness direction of the leg portion 32 intersects (perpendicular to or substantially perpendicular to) both the plate width direction of the top plate portion 31 and the plate thickness direction of the top plate portion 31. Accordingly, a direction in which the leg portion 32 extends from the connection position, in which the leg portion is connected to the top plate portion 31, to the far side end E3 of the leg portion 32 with respect to the top plate portion 31, that is, the length direction of the leg portion 32, corresponds to or substantially corresponds to the plate thickness direction of the top plate portion 31.

In each of the leads 20, a pair of leg main surfaces 35 and 36 and a pair of leg edge surfaces 37 and 38 form the outer surface of the leg portion 32. The leg main surface (the first leg main surface) 35 faces one side in the plate thickness direction of the leg portion 32, that is, one side in the length direction of the top plate portion 31. The leg main surface (the second leg main surface) 36 faces the side opposite to the main leg main surface 35 in the plate thickness direction of the leg portion 32, that is, the length direction of the top plate portion 31. In the present embodiment, the leg main surface 35 faces a side at which the extension end E1 of the top plate portion 31 is positioned in the length direction of the top plate portion 31, while the top plate portion 36 faces the side opposite to the side at which the extension end E1 of the top plate portion 31 is positioned in the length direction of the top plate portion 31. In the present embodiment, each of the leg main surfaces 35 and 36 is parallel to or substantially parallel to both the plate thickness direction of the top plate portion 31 and the plate width direction of the top plate portion 31, from the connection position of the leg portion 32 to the top plate portion 31 up to the far side end E3 of the leg portion 32 with respect to the top plate portion 31. Accordingly, each of the leg main surfaces 35 and 36 is perpendicular to or substantially perpendicular to the length direction of the top plate portion 31 from the connection position of the leg portion 32 to the top plate portion 31 up to the far side end E3 of the leg portion 32 with respect to the top plate portion 31.

In one of the edges of the leg portion 32 in the plate width direction of the leg portion 32 (the plate width direction of the top plate portion 31), the leg edge surface (the first leg edge surface) 37 relays between the leg main surfaces 35 and 36 and continuously extends from the leg main surface 35 to the leg main surface 36 along the plate thickness direction of the leg portion 32 (the length direction of the top plate portion 31). The leg edge surface 37 faces one side in the plate width direction of the leg portion 32. Furthermore, in the edge opposite to the leg edge surface 37 in the plate width direction of the leg portion 32 (the plate width direction of the top plate portion 31), the leg edge surface (the second leg edge surface) 38 relays between the leg main surfaces 35 and 36 and continuously extends from the leg main surface 35 to the leg main surface 36 along the plate thickness direction of the leg portion 32 (the length direction of the top plate portion 31). The leg edge surface 38 faces the side opposite to the leg edge surface 37 in the plate width direction of the leg portion 32. In the present embodiment, each of the leg edge surfaces 37 and 38 is parallel to or substantially parallel to both the plate thickness direction of the top plate portion 31 and the length direction of the top plate portion 31 from the connection position of the leg portion 32 to the top plate portion 31 up to the far side end E3 of the leg portion 32 with respect to the top plate portion 31. Accordingly, each of the leg edge surfaces 37 and 38 is perpendicular to or substantially perpendicular to the plate width direction of the top plate portion 31 from the connection position of the leg portion 32 to the top plate portion 31 up to the far side end E3 of the leg portion 32 with respect to the top plate portion 31.

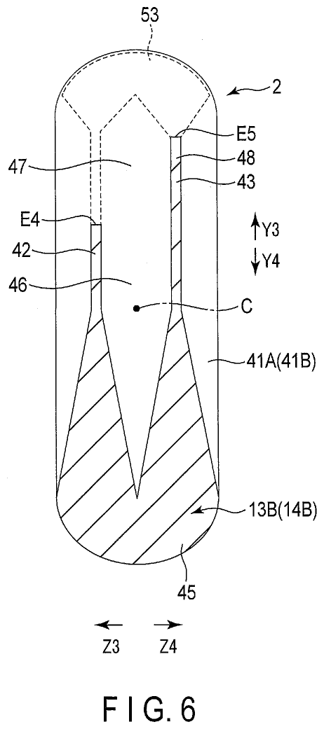

FIG. 6 shows a configuration of the electrode group 2 and the current collecting tab 13B or 14B. FIG. 6 shows a cross section perpendicular to or substantially perpendicular to the length direction of the electrode group 2. As shown in FIGS. 2, 4 to 6, etc., in the electrode group 2, one end in the length direction is provided with an electrode group end surface 41A, and the other end opposite to the electrode group end surface 41A in the length direction is provided with an electrode group end surface 41B. The electrode group end surfaces 41A and 41B face the sides opposite to each other in the length direction of the electrode group 2, and each of the electrode group end surfaces 41A and 41B faces outwardly in the length direction of the electrode group 2. In the battery 1, each of the electrode group end surfaces 41A and 41B faces outwardly in the lateral direction. The positive electrode current collecting tab 13B protrudes from the electrode group end surface 41A toward the side which the electrode group end surface 41A faces. The negative electrode current collecting tab 14B protrudes from the electrode group end surface 41B toward the side which the electrode group end surface 41B faces. In the battery 1, each of the current collecting tabs 13B and 14B protrudes toward the outside in the lateral direction with a root position being set to a corresponding one of the electrode group end surfaces 41A and 41B.

Each of the current collecting tabs 13B and 14B includes tab extension portions 42 and 43 and a tab side portion 45. The tab extension portion (the first tab extension portion) 42 extends along the width direction of the electrode group 2. The tab extension portion (the second tab extension portion) 43 is formed in a position away from the tab extension portion 42 in the thickness direction of the electrode group 2 and extends along the width direction of the electrode group 2. The tab extension portions 42 and 43 are formed as described in the above. This formation creates a space 46 between the tab extension portions 42 and 43 in the thickness direction of the electrode group 2. In each of the current collecting tabs 13B and 14B, the tab side portion 45 forms one of the ends (edges) in the width direction of the electrode group 2. In each of the tab extension portions 42 and 43, one of the ends is connected to the tab side portion 45. The tab side portion 45 relays between the tab extension portions 42 and 43. The tab extension portion 43 is folded in the tab side portion 45 with respect to the tab extension portion 42. In the present embodiment, the tab extension portion 42 is continuous with the tab extension portion 43 only on the condition that the tab side portion 45 intervenes therebetween.

In each of the current collecting tabs 13B and 14B, the space 46 between the tab extension portions 42 and 43 is open in an opening 47 toward the side opposite to the tab side portion 45 in the width direction of the electrode group 2. The opening 47 is formed between a far side end E4 of the tab extension portion 42 with respect to the tab side portion 45 and a far side end E5 of the tab extension portion 43 with respect to the tab side portion 45. The tab side portion 45 is adjacent to the space 46 from the side opposite to the opening 47 in the width direction of the electrode group 2. The space 46 is not open on the side opposite to the opening 47 in the width direction of the electrode group 2. The space 46 created in each of the current collecting tabs 13B and 14B is open toward the outside in the length direction of the electrode group 2. The tab extension portions 42 and 43 and the tab side portion 45 are formed as described in the above. In the present embodiment, this forms each of the current collecting tabs 13B and 14B into a letter U shape or a substantially letter U shape when viewed from the outside in the length direction of the electrode group 2.

In each of the current collecting tabs 13B and 14B, the far side end E5 of the tab extension portion 43 with respect to the tab side portion 45 is positioned further away from the tab side portion 45 in the width direction of the electrode group 2 as compared to the far side end E4 of the tab extension portion 42 with respect to the tab side portion 45. Therefore, the tab extension portion (the second tab extension portion) 43 extends to a position further away from the tab extension portion 45 in the width direction of the electrode group 2 as compared to the tab extension portion (the first tab extension portion) 42. Therefore, the tab extension portion 43 includes an additional extension part 48 which extends beyond the tab extension portion 42 (the far side end E4) toward a side away from the tab side portion 45.

In the battery 1, in each of the current collecting tabs 13B and 14B, each of the tab extension portions 42 and 43 extends along the height direction, and the tab extension portion (the second tab extension portion) 43 is formed away from the tab extension portion (the first tab extension portion) 42 in the depth direction. In the battery 1, in each of the current collecting tabs 13B and 14B, the tab side portion 45 is arranged on the side opposite to the terminal 16, that is, the side at which the bottom wall 6 is positioned, with respect to the tab extension portions 42 and 43 in the height direction. Accordingly, in each of the current collecting tabs 13B and 14B, the space 46 between the tab extension portions 42 and 43 is open in the opening 47 toward a side at which the terminal 16 is positioned in the height direction of the battery 1. In each of the current collecting tabs 13B and 14B, the space 46 is open toward the outside in the lateral direction of the battery 1, also.

In the battery 1, in each of the current collecting tabs 13B and 14B, the far side end E5 of the tab extension portion 43 with respect to the tab side portion 45 is positioned closer to each terminal 16 as compared to the far side end E4 of the tab extension portion 42 with respect to the tab side portion 45. Therefore, the tab extension portion (the second tab extension portion) 43 extends to a position closer to each terminal 16 in the height direction of the battery 1 as compared to the tab extension portion (the first tab extension portion) 42. Therefore, in the tab extension portion 43, the additional extension part 48 extends beyond the tab extension portion (the far side end E4) toward the side at which each terminal 16 is positioned in the height direction of the battery 1.

As shown in FIGS. 2, 4, 5, etc., in the inner cavity 8 of the battery 1, the top plate portion 31 of each of the leads 20 in a pair is arranged between the electrode group 2 and the electrode group holder 23 in the height direction of the battery 1, and is sandwiched therebetween. In each of the leads 20, the length direction of the top plate portion 31 corresponds to or substantially corresponds to the lateral direction of the battery 1 (the length direction of the electrode group 2), and the plate width direction of the top plate portion 31 corresponds to or substantially corresponds to the depth direction of the battery 1 (the thickness direction of the electrode group 2). In each of the leads 20, the plate thickness direction of the top plate portion 31 corresponds to or substantially corresponds to the height direction of the battery 1 (the width direction of the electrode group 2). In the top plate portion 31 in each of the leads 20, the extension end E1 and the through-hole 33 are positioned further inwardly in the lateral direction of the battery 1 as compared to the extension end E2 (the bending position of the leg portion 32 with respect to the top plate portion 31). Therefore, the top plate portion 31 of each of the leads 20 extends outwardly in the lateral direction of the battery 1 from the extension end E1 to the extension end E2. In the battery 1, a corresponding one of the terminals 16, that is, a corresponding one of the positive electrode terminal and the negative electrode terminal, is connected to the top plate portion 31 of each of the leads 20 in a pair. In each of the leads 20, a corresponding one of the terminals 16 is inserted into the through-hole 33 of the top plate portion 31. A corresponding one of the terminals 16 is connected to each of the leads 20 by a fixation by caulking in the through-hole 33.

In the inner cavity 8 of the battery 1, the leg portion 32 of each of the leads 20 in a pair is arranged between a corresponding one of the side walls 11 and the electrode group 2 in the lateral direction of the battery 1. In each of the leads 20, the plate thickness direction of the leg portion 32 corresponds to or substantially corresponds to the depth direction of the battery 1 (the thickness direction of the electrode group 2), while the plate thickness direction of the leg portion 32 corresponds to or substantially corresponds to the lateral direction of the battery 1 (the length direction of the electrode group 2). In each of the leads 20, the leg portion 32 is arranged outwardly with respect to the through-hole 33, that is, the connection position to a corresponding one of the terminals 16, in the lateral direction of the battery 1.

In each of the leads 20, the leg portion 32 is bent with respect to the top plate portion 31 toward the side at which the electrode group 2 and the bottom wall 6 are positioned in the height direction of the battery 1. The bending line of the leg portion 32 with respect to the top plate portion 31 extends along the depth direction of the battery 1. In each of the leads 20, the leg portion 32 extends straight or substantially straight along the height direction of the battery 1 from the bending position with respect to the top plate portion 31 (the extension end E2 of the top plate portion 31) up to the far side end E3 with respect to the top plate portion 31. In each of the current collecting tabs 13B and 14B, the leg portion 32 of a corresponding one of the leads 20 is inserted through the opening 47 into the space 46 between the tab extension portions 42 and 43. Accordingly, the leg portion 32 of each of the leads 20 is inserted between the tab extension portions 42 and 43, in a corresponding one of the current collecting tabs 13B and 14B, from the side at which each terminal 16 is positioned in the height direction of the battery 1.

In the leg portion 32 of each of the leads 20, the leg main surface (the first leg main surface) 35 faces inwardly in the lateral direction of the battery 1 and faces a corresponding one of the electrode group end surfaces 41A and 41B. The leg main surface (the second leg main surface) 36 faces outwardly in the lateral direction of the battery 1. In each of the leads 20, each of the leg main surfaces 35 and 36 of the leg portion 32 is formed in parallel to or substantially parallel to a corresponding one of the electrode group end surfaces 41A and 41B and is parallel to or substantially parallel to both of the height direction of the battery 1 and the depth direction of the battery 1 from the connection position of the leg portion 32 to the top plate portion 31 up to the far side end E3 of the leg portion 32 with respect to the top plate portion 31. In the leg portion 32 of each of the leads 20, the leg edge surface (the first leg edge surface) 37 faces one side in the depth direction of the battery 1, and the leg edge surface (the second leg edge surface) 38 faces the side opposite to the leg edge surface 37 in the depth direction of the battery 1. In each of the leads 20, each of the leg main surfaces 37 and 38 of the leg portion 32 is parallel to or substantially parallel to both of the height direction of the battery 1 and the lateral direction of the battery 1 from the connection position of the leg portion 32 to the top plate portion 31 up to the far side end E3 of the leg portion 32 with respect to the top plate portion 31.

As shown in FIGS. 2, 4, 5, etc., two pairs of clips (backup leads) 51 and 52 are arranged in the inner cavity of the outer container 3. In each of the current collecting tabs 13B and 14B, a plurality of band-like portions are stacked in each of the tab extension portions 42 and 43. In the tab extension portion (the first tab extension portion) 42 of each of the current collecting tabs 13B and 14B, the plurality of stacked band-like portions are clipped by a corresponding one of the clips 51 that forms a pair. In the tab extension portion (the second tab extension portion) 43 of each of the current collecting tabs 13B and 14B, the plurality of stacked band-like portions are clipped by a corresponding one of the clips 52 that forms a pair. In the tab extension portion 43, the additional extension part 48 is clipped by the clip 52.

In each of the leads 20, the leg portion 32 is joined (connected) to a corresponding one of the current collecting tabs 13B and 14B. In each of the current collecting tabs 13B and 14B according to the present embodiment, the leg edge surface (the first leg edge surface) 37 of the leg portion 32 of a corresponding one of the leads 20 is joined to the tab extension portion (the first tab extension portion) 42. The leg edge surface 37 of the leg portion 32 is joined to the tab extension portion 42 with the clip 51 intervening therebetween and is joined to the tab extension portion 42 from the side at which the tab extension portion 43 is positioned in the depth direction of the battery 1.

In each of the current collecting tabs 13B and 14B, the leg edge surface (the second leg edge surface) 38 of the leg portion 32 of a corresponding one of the leads 20 is joined to the additional extension part 48 of the tab extension portion (the second tab extension portion) 43. The leg edge surface 38 of the leg portion 32 is joined to the tab extension portion 43 with the clip 52 intervening therebetween and is joined to the tab extension portion 43 from the side at which the tab extension portion 42 is positioned in the depth direction of the battery 1. In the tab extension portion 43 according to present embodiment, the leg edge surface 38 is joined to the additional extension part 48. Accordingly, a joining position of the leg edge surface 38 to the tab extension portion 43 (the second joining position) is formed closer to each terminal in the height direction 1 as compared to a joining position of the leg edge surface 37 to the tab extension portion 42 (the first joining position).

Herein, manufacturing of the battery 1 will be described. In manufacturing of the battery 1, the electrode group 2 is formed by, for example, winding the positive electrode 13, the negative electrode 14, etc., around the winding axis C. At this time, in the electrode group 2, the current collecting tabs 13B and 14B are formed in such a manner as to protrude outwardly in the length direction of the electrode group 2. Furthermore, the current collecting tabs 13B and 14B are formed in such a manner as to protrude toward the sides opposite to each other. In formation of each of the current collecting tabs 13B and 14B, a part of each protrusion portion protruding outwardly in the length direction in the electrode group 2 is cut off. For example, in each of the protrusion portions protruding outwardly in the length direction of the electrode group 2, a part 53 indicated by the dashed line in FIG. 6 is cut off. This results in the formation of a current collecting tab (a corresponding one of the current collecting tabs 13B and 14B) including the tab extension portions 42 and 43 and the tab side portion 45.

In each of the current collecting tabs 13B and 14B before the part 53 is cut off, the part 53 forms an end on the side opposite to the tab side portion 45 in the width direction of the electrode group 2. The part 53 is adjacent to the space 46 between the tab extension portions 42 and 43 from the side opposite to the tab side portion 45. In each of the protrusion parts (the current collecting tabs 13B and 14B) before the part 53 is cut off, the tab extension portion 42 is continuous to the tab extension portion 43 with the tab side portion 45 intervening therebetween and is continuous to the tab extension portion 43 with the part 53 intervening therebetween, too. In each of the current collecting tabs 13B and 14E, the opening 47 of the space 46 is created by cutting the part 53. In this opening 47, the space 46 is open toward the side opposite to the tab side portion 45 in the width direction of the electrode group 2. In the present embodiment, the part 53 is cut off in such a manner as to realize a state in which the additional extension part 48 of the tab extension portion 43 is formed.

In manufacturing of the battery 1, the pair of leads 20 is formed. In this formation, each of the leads 20 is formed in such a manner that the top plate portion 31 and the leg portion 32 are configured as described in the above. Thus, in each of the leads 20, the leg portion 32 is bent with respect to the top plate portion 31 toward one side in the plate thickness direction of the top plate portion 31 in such a manner that the bending line extends along the plate thickness direction of the top plate portion 31. The leg portion 32 is formed straight or substantially straight from the bending position with respect to the top plate portion 31 up to the far side end E3 with respect to the top plate portion 31.

In manufacturing of the battery 1, the pair of terminals 16 is attached to the outer surface of the lid member 5, and the top plate portion 31 of a corresponding one of the leads 20 is connected to each of the terminals 16. With the top plate portion 31 of a corresponding one of the leads 20 being connected to each of the terminals 16, each of the terminals 16 and each of the top plate portions 31 are arranged in a position deviated from the electrode group 2 in the width direction of the electrode group 2.

In each of the current collecting tabs 13B and 14B, the leg portion 32 of a corresponding one of the leads 20 is inserted into the space 46 between the tab extension portions 42 and 43 from the side at which each terminal 16 is positioned in the width direction of the electrode group 2, that is, through the opening 47. This leads to a state in which the leg portion 32 of each of the leads 20 extends along the width direction of the electrode group 2 from the bending position with respect to the top plate portion 31 up to the far side end E3 with respect to the top plate portion 31. In the leg portion 32 of each of the leads 20, the leg main surface 35 faces a corresponding one of the electrode group end surfaces 41A and 41B, and the leg main surface 36 faces outwardly in the length direction of the electrode group 2. In the leg portion 32 of each of the leads 20, the leg edge surface 37 faces one side in the thickness direction of the electrode group 2, and the leg edge surface 38 faces the side opposite to the leg edge surface 37 in the thickness direction of the electrode group 2.

In each of the current collecting tabs 13B and 14B, the leg edge surface 37 of the leg portion 32 of a corresponding one of the leads 20 is joined to the tab extension portion 42 by means of ultrasonic welding, etc. In this joining, with the tab extension portion 42 being clipped by the clip 51, the leg edge surface 37 of the leg portion 32 is joined to the tab extension portion 42 from the side at which the tab extension portion 43 is positioned in the thickness direction of the electrode group 2. In each of the current collecting tabs 13B and 14B, the leg edge surface 38 of the leg portion 32 of a corresponding one of the leads 20 is joined to the additional extension part 48 of the tab extension portion 43 by means of ultrasonic welding, etc. In this joining, with the tab extension portion 43 being clipped by the clip 52, the leg edge surface 38 of the leg portion 32 is joined to the tab extension portion 43 from the side at which the tab extension portion 42 is positioned in the thickness direction of the electrode group 2. By the leg portion 32 of a corresponding one of the leads 20 being joined to each of the current collecting tabs 13B and 14B, the electrode group 2 is electrically connected to each of the terminals 16.

In manufacturing of the battery 1, an assembly including the electrode group 2, the leads 20, the lid member 5, the terminals 16, etc., is inserted into the inner cavity 8 of the outer container 3, and the electrode group 2 and the leads 20 are housed inside the inner cavity 8. The lid member 5 is then attached to the peripheral wall 7 of the outer container 3. In this manner, the opening of the inner cavity 8 is covered with the lid member 5.

In each of the leads 20 according to the present embodiment, the leg portion 32 is bent with respect to the top plate portion 31 in a state in which the bending line on the bending position with respect to the top plate portion 31 extends along the plate width direction of the top plate portion 31. The plate width direction of the leg portion 32 corresponds to or substantially corresponds to the plate width direction of the top plate portion 31. Therefore, unlike the configuration in which the leg portion is bent with respect to the top plate portion 31 in such a manner that the bending line extends along the length direction of the top plate portion 31 (the extension direction from the extension end E1 to the extension end E2), there is no need to provide the top plate portion 31 with a notch in the connection position to the leg portion 32 or in the vicinity of this connection position. This secures a large cross-section of the top plate portion 31 in a part to which the leg portion 32 is connected and in the vicinity of this part, that is, the extension end E2 and its vicinity.

In the present embodiment, furthermore, the leg portion 32 of each of the leads 20 extends straight or substantially straight along the height direction of the battery 1 (the plate thickness direction of the top plate portion 31) from the bending position with respect to the top plate portion 31 up to the far side end E3 with respect to the top plate portion 31. That is, the leg portion 32 is not bent in the lateral direction of the battery 10 (the length direction of the top plate portion 31) and the depth direction of the battery 1 (the plate width direction of the top plate portion 31) from the connection position to the top plate portion 31 up to the far side end E3 with respect to the top plate portion 31. This secures, in each of the leads 20, the short extension length between a joining position (a connection position) to a corresponding one of the current collecting tabs 13B and 14B and a connection position (the through-hole 33) to a corresponding one of the terminals 16. That is, the leads 20 secure a short route length of an electric route between the electrode group 2 and the terminals 16.

As described in the above, in each of the leads 20 according to the present embodiment, the large cross-section of the top plate portion 31 is secured, while the short route length between the electrode group 2 and the terminals 16 is secured. This secures a low electric resistance of the leads 20. With the low electric resistance of the leads 20, which serve the electric route between the electrode group 2 and the terminals 16, a higher output of the battery 1 is achieved.

On the outer surface of the leg portion 32 in each of the leads 20 according to the present embodiment, the leg edge surface 37 faces one side in the width direction of the top plate portion 31, and the leg edge surface 38 faces the side opposite to the leg edge surface 37 in the width direction of the top plate portion 31. Therefore, in each of the leads 20 even with the configuration in which the leg portion 32 is bent with respect to the top plate portion 31 as described in the above, the leg edge surface 37 can be easily joined to the tab extension portion 42 of a corresponding one of the current collecting tabs 13B and 14B from one side in the thickness direction of the electrode group 2. Similarly, in each of the leads 20, the leg edge surface 38 can also be easily joined to the tab extension portion 43 of a corresponding one of the current collecting tabs 13B and 14B from a side at which the tab extension portion 42 is positioned in the thickness direction of the electrode group 2. Accordingly, the present embodiment secures, even with the configuration in which the leg portions 32 are bent with respect to the top plate portions 31, the workability of the work of joining a corresponding one of the leads 20 to each of the current collecting tabs 13B and 14B.

In each of the current collecting tabs 13B and 14B according to the present embodiment, the space 46 between the tab extension portions 42 and 43 is open in an opening 47 toward the side opposite to the tab side portion 45 in the width direction of the electrode group 2. Therefore, in each of the leads 20, even with the configuration in which the leg portion 32 extends straight or substantially straight as described in the above, the leg portion 32 can be easily inserted through the opening 47 into the space created in a corresponding one of the current collecting tabs 13B and 14B. By the leg portion 32 being easily inserted into the space 46 created in a corresponding one of the current collecting tabs 13B and 14B, the workability of the work of joining a corresponding one of the leads 20 to each of the current collecting tabs 13B and 14B is further improved.

In the present embodiment, in formation of the electrode group 2, the opening 47 of the space 46 is formed by cutting the part 53 out of each of the current collecting tabs 13B and 14B (the protrusion parts protruding outwardly in the length direction of the electrode group 2). Therefore, even with the configuration in which the opening 47 of the space 46 is formed in each of the current collecting tabs 13B and 14B, the electrode group 2 is formed without or almost without increasing labor, etc.

Furthermore, in each of the current collecting tabs 13B and 14B according to the present embodiment, the additional extension part 48 of the tab extension portion 43 extends beyond the tab extension part 42 (the far side end E4) toward the side at which each terminal 16 is positioned (a side away from the tab side portion 45) in the height direction of the battery 1. In each of the leads 20, the leg edge surface 38 of the leg portion 32 is joined to the additional extension part 48 of the tab extension portion 43. Accordingly, a joining position of the leg edge surface 38 to the tab extension portion 43 is formed closer to each terminal 16 in the height direction of the battery 1 as compared to a joining position of the leg edge surface 37 to the tab extension portion 42. This secures, even in the case where a corresponding one of the leg portions 32 is joined on two joining positions to each of the current collecting tabs 13B and 14B, the workability of the work of joining a corresponding one of the leads 20 to each of the current collecting tabs 13B and 14B.

(Modifications)

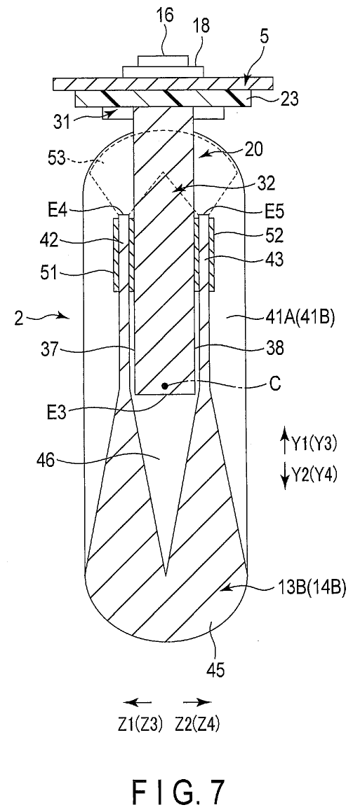

In the first modification shown in FIG. 7, the far side end E5 of the tab extension portion 43 with respect to the tab side portion 45 is not deviated or is rarely deviated in the height direction of the battery 1 (the width direction of the electrode group 2) with respect to the far side end E4 of the tab extension portion 42 with respect to the tab side portion 45. Therefore, the additional extension part 48 is not formed in the tab extension portion 43. The joining position (the second joining position) of the leg edge surface (the second leg edge surface) 38 to the tab extension portion (the second tab extension portion) 43 is not deviated or is rarely deviated in the height direction of the battery 1 with respect to the joining position (the first joining position) of the leg edge surface (the first leg edge surface) 37 to the tab extension portion (the first tab extension portion) 42. Also in the present modification, in each of the current collecting tabs 13B and 14B, the space 46 is open in the opening 47 toward the side opposite to the tab side portion 45 in the width direction of the electrode group 2. In formation of each of the current collecting tabs 13B and 14B, a portion (the part indicated by the dashed line in FIG. 7) of each protrusion portion protruding outwardly in the length direction in the electrode group 2 is cut off, thereby creating the opening 47.

In another modification, similarly to the first modification, the far side end E5 of the tab extension portion 43 is not deviated or is rarely deviated in the height direction of the battery 1 (the width direction of the electrode group 2) with respect to the far side end E4 of the tab extension portion 42. However, in the present modification, only the leg edge surface 37 is joined to the tab extension portion 42, and the leg edge surface 38 is not joined to the tab extension portion 43.

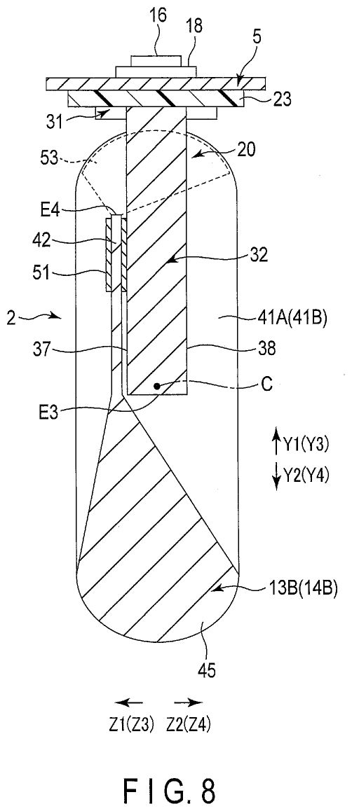

In the second modification shown in FIG. 8, each of the current collecting tabs 13B and 14B is not provided with the tab extension portion 43. Therefore, the space 46 and the opening 47 are not formed in each of the current collecting tabs 13B and 14B. In the present modification also, the tab extension portion 42 and the tab side portion 45 are formed in each of the current collecting tabs 13B and 14B. In each of the leads 20, the leg edge surface 37 of the leg portion 32 is joined to the tab extension portion 42 of a corresponding one of the current collecting tabs 13B and 14B from one side in the depth direction of the battery 1 (the thickness direction of the electrode group 2). In the present modification also, in formation of each of the current collecting tabs 13B and 14B, a portion (the part 53 indicated by the dashed line in FIG. 8) of each protrusion portion protruding outwardly in the length direction in the electrode group 2 is cut off. In each of the current collecting tabs 13B and 14B before the part 53 is cut off, an end of the tab extension portion 42, which is opposite to the tab side portion 45, is connected to the part 53.

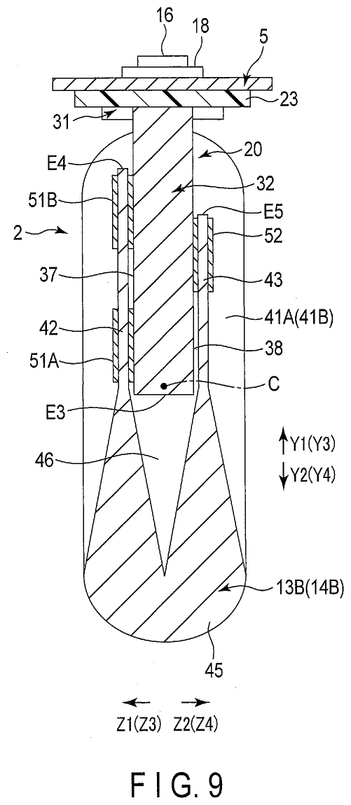

As a modification of the first embodiment, in each of the current collecting tabs 13B and 14B, two clips (backup leads) may be attached to at least one of the tab extension portions 42 and 43. For example, in a third modification shown in FIG. 9, two clips, i.e., a first clip (a first backup lead) 51A and a second clip (a second backup lead) 51B, are attached to the tab extension portion 42. The clips 51A and 51B are attached to the tab extension portion 42 in positions away from each other in the width direction of the electrode group 2. In the present modification, the tab extension portion 42 is joined to the leg edge surface 37 of the leg portion 32 of each of the leads 20 with the first clip 51A intervening between the tab extension portion 42 and the leg edge surface 37, and is joined to the leg edge surface 37 of each of the leads 20 in a position away from the first clip 51A in the height direction of the battery 1 with the second clip 51B intervening between the tab extension portion 42 and the leg edge surface 37. That is, the tab extension portion 42 is joined to the leg edge surface 37 of the leg portion 32 of each lead in two different locations.

In another modification, a structure of the electrode group 2 may not be a winding structure but a stack structure in which the plurality of positive electrodes 13 and the plurality of negative electrodes 14 are alternately stacked. In such a case also, in the electrode group 2, the positive electrode 13 and the negative electrode 14 are electrically insulated from each other by means of a separator, etc. In the case where the electrode group 2 has the stack structure, the opening 47 of the space 46, etc., can be created without cutting off a portion of each protrusion part protruding outwardly in the length direction of the electrode group 2. That is, the leg edge surface 37 of the leg portion 32 extending straight or substantially straight can be joined to the tab extension portion 42 without cutting a portion out of each of the protruding parts (the current collecting tabs 13B and 14B) protruding outwardly in the length direction of the electrode group 2.

In all of the modifications described in the above, each of the leads 20 includes the top plate portion 31 and the leg portion 32 bent with respect to the top plate portion 31 toward one side in the plate thickness direction of the top plate portion 31, as in the first embodiment, etc. The plate width direction of the leg portion 32 corresponds to or substantially corresponds to the plate width direction of the top plate portion 31. As in the first embodiment, etc., this secures a large cross-section of the top plate portion 31 in a part to which the leg portion 32 is connected and in the vicinity of this part, that is, the extension end E2 and its vicinity. In all of the modifications described in the above, furthermore, the leg portion 32 of each of the leads 20 extends straight or substantially straight along the height direction of the battery 1 (the plate thickness direction of the top plate portion 31) from the bending position with respect to the top plate portion 31 up to the far side end E3 with respect to the top plate portion 31, as in the first embodiment, etc. This secures, in each of the leads 20, the short extension length between a joining position to a corresponding one of the current collecting tabs 13B and 14B and a connection position (the through-hole 33) to a corresponding one of the terminals 16. Accordingly, in all of the modifications described in the above, a low electric resistance of the leads 20 is secured and a higher output of the battery 1 is achieved.

Both of the electric connection structure on the positive electrode side from the electrode group 2 to the positive electrode terminal with the positive electrode current collecting tab 13B and the positive electrode side lead intervening therebetween, and the electric connection structure on the negative electrode side from the electrode group 2 to the negative electrode terminal with the negative electrode current collecting tab 14B and the negative electrode side lead intervening therebetween, do not have to be configured in a similar manner to those of one of the embodiments and the modifications described in the above. That is, it suffices that at least one of the connection structure on the positive electrode side and the connection structure on the negative electrode side be configured in a similar manner as that of one of the embodiments and the modifications described in the above.

According to at least one of the embodiments or examples, in the lead, the leg portion is bent with respect to the top plate portion toward a side at which the electrode group is positioned in the height direction of the battery, and the bending line with respect to the top plate portion of the leg portion extends along the depth direction of the battery. The leg portion of the lead extends straight along the height direction of the battery from the bending position with respect to the top plate portion up to the far side end with respect to the top plate portion. The leg edge surface of the outer surface of the leg portion faces one side in the depth direction of the battery and is joined to the current collecting tab. In this manner, a battery which can secure a low electric resistance of the lead and achieve a higher output can be provided.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A battery comprising:
an electrode group including a positive electrode and a negative electrode;
a current collecting tab protruding outwardly in a lateral direction in the electrode group;
a terminal arranged in such a manner as to be deviated from the electrode group in a height direction intersecting the lateral direction; and
a lead electrically connecting the electrode group and the terminal,
wherein the lead includes:
a top plate portion to which the terminal is connected;
a leg portion that is bent with respect to the top plate portion toward a side at which the electrode group is positioned in the height direction, that is provided with a bending line with respect to the top plate portion along a depth direction intersecting both the lateral direction and the height direction, and that extends straight along the height direction from a bending position with respect to the top plate portion to a far side end with respect to the top plate portion; and
a first leg edge surface that faces one side in the depth direction in an outer surface of the leg portion, and is joined to the current collecting tab.

2. The battery according to claim 1, wherein:
the current collecting tab includes:
the first tab extension portion extending along the height direction; and
a second tab extension portion that is formed away from the first tab extension portion in the depth direction, and extends along the height direction;
the leg portion of the lead is inserted between the first tab extension portion and the second tab extension portion from a side at which the terminal is positioned in the height direction; and
the first leg edge surface of the lead is joined to the first tab extension portion from a side at which the second tab extension portion is positioned in the depth direction.

3. The battery according to claim 2, wherein:
the leg portion of the lead includes a second leg edge surface facing a side opposite to the first leg edge surface in the outer surface; and
the second leg edge surface is joined to the second tab extension portion from a side at which the first tab extension portion is positioned in the depth direction.

4. The battery according to claim 3, wherein:
the second tab extension portion extends to a position closer to the terminal in the height direction as compared to the first tab extension portion; and
a joining position of the second leg edge surface to the second tab extension portion is formed closer to the terminal in the height direction as compared to a joining position of the first leg edge surface to the first tab extension portion.

5. The battery according to claim 1, wherein:
the electrode group includes an electrode group end surface facing outwardly in the lateral direction;
the current collecting tab protrudes outwardly in the lateral direction from the electrode group end surface;
the leg portion of the lead includes:
a first leg main surface that faces the electrode group end surface in the outer surface, and is formed in parallel to the electrode group end surface from the bending position of the leg portion with respect to the top plate portion up to the far side end of the leg portion with respect to the top plate portion; and
a second leg main surface that faces a side opposite to the first leg main surface in the outer surface, and is formed in parallel to the electrode group end surface from the bending position of the leg portion with respect to the top plate portion up to the far side end of the leg portion with respect to the top plate portion; and
the first leg edge surface relays between the first leg main surface and the second leg main surface on an edge in one side of the leg portion.

6. The battery according to claim 1, wherein:
the current collecting tab is at least one of a positive electrode current collecting tab protruding toward one side in the lateral direction in the electrode group and a negative electrode current collecting tab protruding toward a side opposite to a side toward which the positive electrode current collecting tab protrudes in the electrode group;
the terminal is at least one of a positive electrode terminal arranged in such a manner as to be deviated from the electrode group toward one side in the height direction and a negative electrode terminal arranged in such a manner as to be deviated from the electrode group toward a side at which the positive electrode terminal is positioned and as to be away from the positive electrode terminal toward a side toward which the negative electrode current collecting tab protrudes in the lateral direction; and
the lead is at least one of a positive electrode side lead electrically connecting the positive electrode current collecting tab and the positive electrode terminal, and a negative electrode side lead electrically connecting the negative electrode current collecting tab and the negative electrode terminal.

7. A manufacturing method of a battery, the method comprising:
forming an electrode group from a positive electrode and a negative electrode, and forming a current collecting tab in the electrode group in such a manner that the current collecting tab protrudes outwardly in a length direction of the electrode group;
forming a lead by bending a leg portion with respect to a top plate portion toward one side in a plate thickness direction of the top plate portion in such a manner that a bending line extends along a plate width direction of the top plate portion, and forming the leg portion in such a manner that the leg portion extends straight from a bending position with respect to the top plate portion to a far side end with respect to the top plate portion;
connecting the top plate portion of the lead to a terminal;
arranging the terminal, to which the top plate portion is connected, in a position deviated from the electrode group in a width direction of the electrode group, which is intersecting the length direction of the electrode group, and arranging the lead in such a manner that the leg portion extends along the width direction of the electrode group from the bending position with respect to the top plate portion up to the far side end with respect to the top plate portion; and
joining to the current collecting tab, in an outer surface of the leg portion arranged along the width direction of the electrode group, a leg edge surface facing one side in a thickness direction of the electrode group, which is intersecting both the length direction of the electrode group and the width direction of the electrode group, and electrically connecting the electrode group and the terminal.
